(19) United States
(12) Patent Application Publication
(10) Pub. No.: US 2006/0282316 A1
(43) Pub. Date: Dec. 14, 2006

(54) Ad click cache on a user device and method

(75) Inventors: Matthew Snyder, Vancouver (CA); Murali Krishna Punaganti Venkata, Vantaa (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/153,826

(22) Filed: Jun. 14, 2005

(51) Int. Cl. G06Q 30/00

(52) U.S. Cl. 705/14

(57) ABSTRACT

An advertisement is stored locally on a memory of a device (such as a mobile station), and the device is used to display the advertisement on at least two distinct occasions. For each individual occasion, information concerning display of the advertisement by the device is stored locally. In response to a triggering condition, the information of the at least two occasions where the advertisement was displayed is sent in a single message to a network entity. Preferably, the information relates to a number of times, since the last such message was sent, that a particular advertisement was displayed, or selected by a user after being displayed, or both. The triggering condition may be a recurring or a non-recurring chronological event, a threshold number of times the advertisement was displayed or selected, or a request for the information from external of the device. A device, apparatus and computer program is also described.

### TECHNICAL FIELD

The present invention relates to portable two-way communication devices with storage and displays for displaying advertisements and the like to users.

### BACKGROUND

Advertisements on personal computers accessing various web pages of the Internet are known, and come in various forms such as pop-up advertisements, banners, and the like. Communications technology is increasingly able to identify specific users or groups of users by their actions on the Internet, such as users who request particular types of web pages, users who respond to certain types of advertisements, on-line polls of users by which users self-identify their demographic groups and interests, actual purchases made by users, and the like. It is known to accumulate and use some or all of this user-related information into customer profiles, which are later used to target further advertisements to particular users or to users that exhibit common traits as evidenced by such past behavior.

One approach to targeting advertising, and associated offerings such as a time-sensitive discount, to users based on previous activity on the Internet is described in U.S. Pat. No. 5,933,811 by Angles and Blattner, entitled “System and Method for Delivering Customized Advertisements within Interactive Communication Systems”. That patent describes customized advertisements that are selected based on consumer profiles, which are then integrated with offerings maintained by different content providers. The preferred interactive communication system interconnects multiple consumer computers, multiple content provider computers and multiple Internet provider computers with an advertisement provider computer. Whenever a consumer directs one of the consumer computers to access an offering existing in one of the content provider computers, an advertising request is sent to the advertisement provider computer. Upon receiving the advertising request, the advertising provider computer generates a custom advertisement based on the consumer's profile. The custom advertisement is then combined with the offering from the content provider computer and displayed to the consumer. The advertisement provider computer also credits a consumer account, a content provider account and an Internet provider account each time a consumer views a custom advertisement. Furthermore, the advertisement provider computer tracks consumer responses to the customized advertisements.

As the above patent describes, the advertisements and offerings are provided in real time to a customer's personal computer via various servers on the Internet. Specific user activity such as clicking on an ad is updated to the Internet entity that collects user profile data in real time also, as well as the monitoring the display of and responses to particular advertisements. Advertising rates for Internet advertising is often predicated on the number of times an ad is displayed, and its effectiveness is often measured based on how many times an ad is clicked once displayed. However, it is becoming increasingly frequent to access the Internet from less robust computing devices, such as web-enabled personal digital assistants (PDAs), mobile telephones, and other personal devices. Personal devices that enable Internet access are necessarily limited in physical size, generally are bandwidth limited for uploads and downloads as compared to personal computers coupled to the Internet via cable or WiFi connection, and suffer from a limited power supply (battery) when used portably. What is needed in the art is a method and apparatus to enable advertisements such as pop-up and banner ads in portable handheld devices, and to accurately track ads displayed and responded to in a reliable manner.

### SUMMARY OF THE EXEMPLARY EMBODIMENTS

The foregoing and other problems are overcome, and other advantages are realized, in accordance with exemplary and non-limiting embodiments of these teachings.

In accordance with an embodiment of the invention is a method for tracking electronic activity on a device. In this method, an advertisement is stored locally on a memory of a device, and the device is used to display the advertisement on at least two distinct occasions. For each individual occasion, information concerning display of the advertisement by the device is stored locally. In response to a triggering condition, the information of the at least two occasions where the advertisement was displayed is sent in a single message to a network entity. Preferably, the information relates to a number of times, since the last such message was sent, that a particular advertisement was displayed, or selected by a user after being displayed, or both.

In accordance with another embodiment of the invention is an electronic device for presenting advertisements to a user. This embodiment of a device includes a graphical display interface, a memory that includes an ad cache for storing an advertisement and various applications, a user input mechanism, and means for linking to a broader communications network. Preferably, the means for linking is transceiver circuitry and an antenna. Also within the device is a digital processor coupled to each of the display interface, the memory, the user input mechanism, and the means for linking. For each distinct instance at which the advertisement is displayed at the graphical user interface, the processor operates to store information concerning display of that advertisement in the memory. The processor also operates to send an indication of the stored information to the broader communication network, via the means for linking. This sending is in response to a triggering condition, of which various exemplary triggering conditions are detailed below.

In accordance with another embodiment of the invention is an apparatus that includes means for graphically displaying data to a user; local means for electronically storing data, computer application instructions, and graphical advertisements; and means for linking to a broader communications network. The apparatus further includes processing means for updating information in the local storing means, where the information concerns display of the graphical advertisement at the graphical displaying means. The processor means is further responsive to a triggering condition for sending an indication of that information through the means for linking.

In accordance with another embodiment of the invention is a program of machine-readable instructions, tangibly embodied on an information bearing medium and executable by a processor. The program of this embodiment is for performing actions directed toward recording advertising activity. The actions include 1) displaying an advertisement from a local memory on at least two distinct occasions; 2) for each individual occasion, storing information concerning display of the advertisement by the device; and 3) responsive to a triggering condition, sending the information of the at least two occasions in a single message to a network entity.

In accordance with another aspect, the present invention is a method of doing business over a network. This method includes downloading to at least one user device an advertisement in electronic form, receiving from the user device a message that contains information concerning multiple instances of the advertisement being displayed on the user device, and invoicing an advertiser in an amount based, at least in part, on the information received from the user device.

In another aspect, the present invention is a network entity that has a transmitter for downloading electronic advertisements to a plurality of user devices for local storage thereon. The network entity also has a receiver for receiving from each of at least some of the plurality of user devices a message that contains information concerning multiple instances of the advertisement being displayed on that user device. The network entity further has means for generating an invoice to an advertiser, an amount of the invoice based at least in part on a consolidation of the information in the received messages. The network entity is not limited to a single body, but may be dispersed among multiple base stations, servers, or other nodes under the control of a common entity.

In another aspect, the present invention is a program of machine-readable instructions, tangibly embodied on an information bearing medium and executable by a digital data processor, to perform actions directed toward displaying an advertisement on user equipment. The actions of this program include displaying on a graphical interface of the user equipment an advertisement that is stored on a local memory of the user equipment, in response to an active application on the user equipment. In some embodiments, the active application that the above action is in response to does not require communications with a network such as a mobile telephony network or the Internet, for example. However, that a second application using a network may be open (active), and even if the user equipment is in active contact with a network, does not negate that the advertisement may be displayed responsive to an application that does not require communication with a network. Further, responsive to an active application includes responsive to first executing a command that opens an overall application; or responsive to different portions of an application (such as a spell checker portion of a word processing program) that may be initiated without departing from this aspect of the invention.

Further aspects of embodiments of the invention are evident from the more detailed description below.

### BRIEF DESCRIPTION OF THE DRAWINGS

The foregoing and other aspects of these teachings are made more evident in the following Detailed Description of Embodiments of the Invention, when read in conjunction with the attached Drawing Figures, wherein:

FIG. 1 is a schematic block diagram of a mobile station according to an embodiment of the present invention alongside a picture of a mobile station within a communication network.

FIG. 2 is a conceptual block diagram of wireless communication between the ad click cache of the mobile station of FIG. 1 and a server for Internet content.

FIG. 3 is a communication diagram showing exchange of information among various entities detailed in FIGS. 1-2.

FIG. 4 is a schematic block diagram of the invention embodied in a network entity, in context with an advertiser and various user devices.

### DETAILED DESCRIPTION OF EMBODIMENTS OF THE INVENTION:

The following terms are used throughout this description and are defined as follows. A mobile station MS is a portable, handheld device capable of wireless two-way communications with a broader communications network other than the mobile telephony network over which the MS sends and receives telephone calls. Examples of a MS include a cellular phone, a personal digital assistant PDA with bi-directional Internet access, a Blackberry® type device, a palmtop computer, and other similarly sized portable devices with similar functionality. Preferably, the broader communications network is the Internet, which may be accessed via a cell-based wireless telephony network or directly via a wireless router. Alternatively, the broader communications network may be any graphically based electronic exchange network in which users are unfamiliar with every other user of the network at any given time. A memory of the MS is any computer readable medium on which computer readable software code may be stored, including RAM, ROM, DRAM, SRAM, removable disks or memory sticks, and the like. A cache is memory used for data storage. Memory is inclusive of all memory of the MS of any type, whether disposed in one or multiple discrete locations within the MS. An application is computer executable software generally stored on the memory of the MS, and a single application need not be stored in the same or contiguous memory locations of the MS. An advertisement is broadly construed, consistent with common understanding of the term, and may be commercial or political. Examples of commercial advertisements include a traditional offer to sell a product or service, or merely an enticement for a user to visit a domain page where the domain page provides an offer to sell. Examples of political advertisements include promotion of or opposition to a political cause or candidate or legislative program, or encouragement or enticement for the viewer to take action such as vote a particular way or contact a public official to voice concern for a specific matter of public interest.

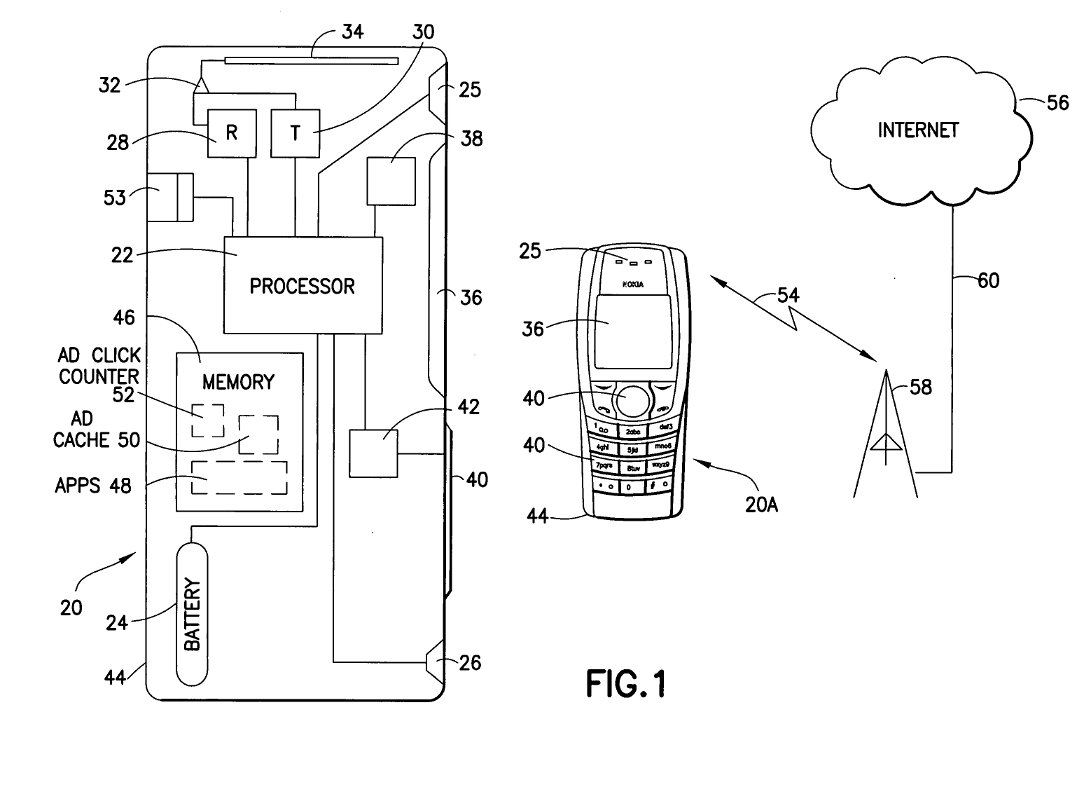

FIG. 1 is a sectional schematic block diagram of a mobile station MS 20 alongside in image 20A of a mobile station exterior in the context of communication networks. The MS 20 includes a digital processor 22 which may be a part of a digital signal processor DSP or a separate general purpose processor, powered by a galvanic power source such as a battery 24 and coupled to transducers 25 (speaker) and 26 (microphone). Receiving circuitry 28 and transmitting circuitry 30 are coupled through a switch or dipole filter 32 to one or more antennas 34. A graphical display interface 36 by which a user views text and images is controlled by a display driver 38. Similarly, a user input pad 40, such as may include buttons, joysticks, and/or touch sensitive areas, is controlled by an input driver 42. The display interface 36 may be fixed relative to a main housing 44 as illustrated, or may be hinged or slideably coupled to extend from the main housing 44 as is common with flip-type and slide-type phones such as the Nokia models N90, N91, 9300, 6822 and 7270.

Computer programs for operating the various sub-systems of the MS 20 are stored in a memory 46, which may be a combination of volatile and non-volatile storage media for data and programs, possibly dispersed among various spatial locations within the housing 44. Within the memory 46 are applications 48, an advertising cache 50, and an ad click counter 52 as will be explained below. Various other buffers, filters, encoders and the like are also within the housing 44, but peripheral to embodiments of the invention. The MS may further include an internally mounted camera 53 as known in the art, for which controlling software and resulting images are stored in the memory 46.

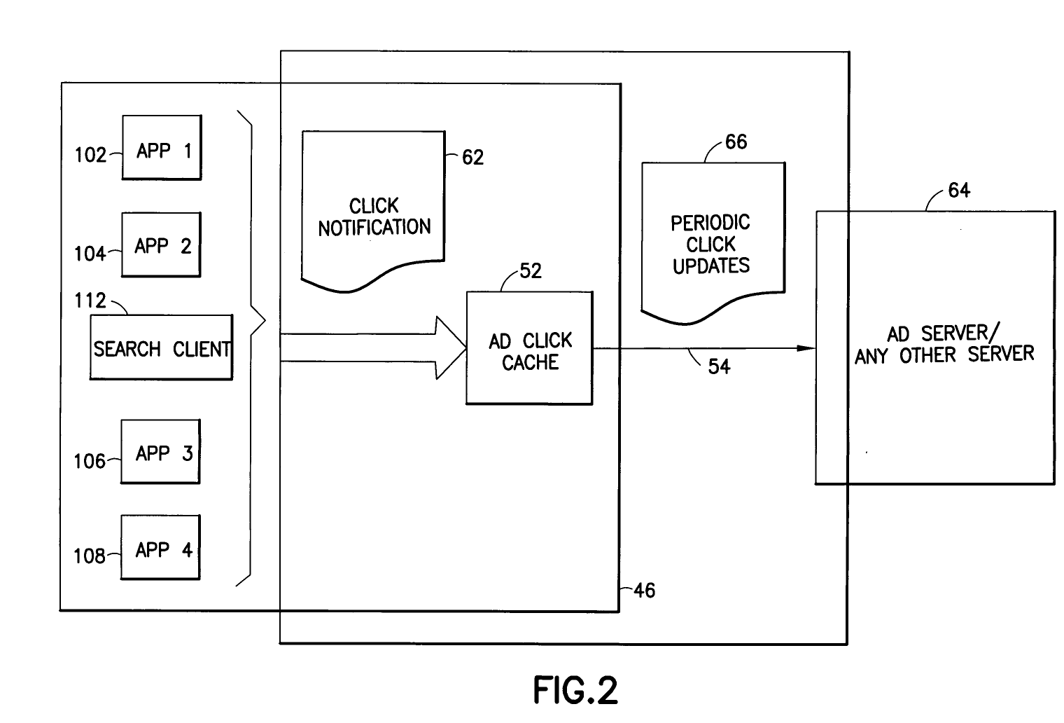

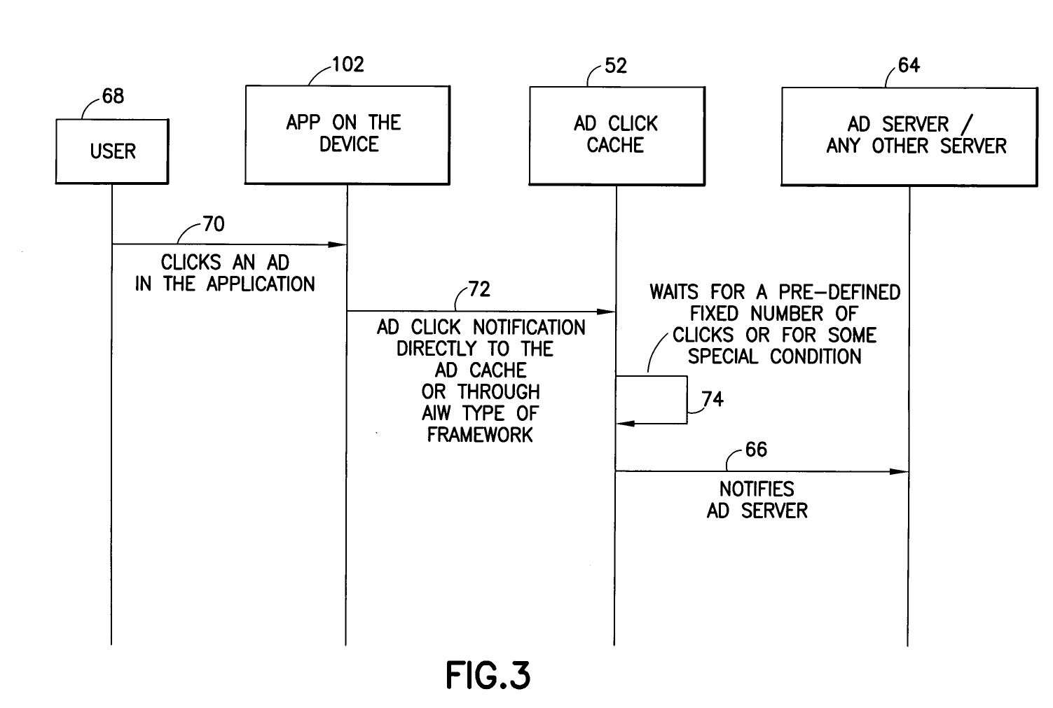

The MS 20/20A is enabled to communicate over a wireless link 54 with a broad-based network such as the Internet 56. As illustrated in FIG. 1, when the MS 20A is a cellular telephone, this communication is via a base station 58 with which the MS 20A establishes a bi-directional link 54 using its transmitter 30, receiver 28, and antenna(s) 34. It is typical that the base station 58 is coupled to the broader network 56 through a hardwire connection 60 which may or may not go through a publicly-switched telephone network PSTN (not shown). Communications specific to embodiments of this invention are detailed below with respect to FIGS. 2-3.

FIG. 2 illustrates the memory 46 of the MS 20 and various different applications and storage caches. A series of applications 102, 104, 106, 108 each have one or more advertisements embedded within them, so that when accessed by a user of the MS 20 the advertisement is displayed, such as a pop-up ad, on the graphical display interface 36. In this manner, the advertisements are not directed to a user based on the user's (retrospective) past activities, but prospectively based on a user's expected activities of opening specific applications. A more efficient manner of managing such embedded advertisements is to embed an identifier for a specific advertisement in the various applications, and store the actual advertisement that is displayed in an ad cache 50. Once the application is opened, the embedded advertisement displays on the graphical user interface or the identifier points the processor 22 via a search client 112 to the actual advertisement in the ad cache 50 so that the advertisement is displayed. The search client 112 acts as an address book, associating the identifiers embedded within the applications to specific advertisements stored at the ad cache 50. Using the search client allows the contents of the ad cache 50 to be dynamically updated without having to modify the underlying code (the identifiers) of the applications themselves. Alternatively, several ads in the ad cache 50 may be associated with one application, and may be selected by the search client 112 for display according to a rotating or priority basis (e.g., ad no. 1 displayed each 1^{st} and 4^{th} time an application is opened per day, ad no. 2 displayed the 2^{nd} time, etc.).

Regardless of how a specific advertisement is selected for display, each distinct instance of the ad being displayed increments a display counter in the ad click cache 52 that reflects number of times a particular ad is displayed. This better keeps track of the number of times each ad is displayed to the user for purposes of revenue sharing, as is known in the art of advertising over electronic networks.

Occasionally the user will ‘click’ on the displayed pop-up or banner ad, such as by depressing a button on the keypad 40, using a stylus on a touch sensitive display screen, voicing an aural command, or otherwise making a user input that is recognizable to the MS 20. This action also triggers a click notification 62 which increments a hit counter in the ad click cache 52 by one. The hit counter preferably keeps a running tally of how many times individual ones of the various advertisements are selected by a user of the device 20. Alternatively, the hit counter may aggregate user selections of two or more advertisements. The ad click cache 52 may additionally or alternatively store more detailed information for each instance of the user selecting a displayed advertisement, such as context in which the ad was displayed (with which specific application, time of day, weekday or weekend, other applications that are open at the time the associated application was initiated, elapsed time during a dynamic ad at which it was selected, etc.). Generally, storing the user selection of an ad with information of the context in which the selection was made is referred to as statistical information of ad hits. Similarly, contextual statistical information may also or alternatively be stored for ad displays.

From time to time, the information stored in the ad click cache 52 (the hit counter, the display counter, and any hit or display statistical information) is uploaded via a wireless link 54 to a server 64 as an advertisement update message 66. The server 64 may be a dedicated ad server or any generic server within the network. Advertisement update messages 66 are not sent each time the display or hit counter is incremented or statistical information otherwise updated within the internal memory of the MS, as that would be overly costly in both bandwidth and power consumption (especially when such updates entail initiating a new cellular link where one is not already active) for the minimal data provided in each message 66. Instead, click update messages 66 may be triggered by any of several thresholds, individually or in combination. Some exemplary thresholds that may trigger sending of an advertisement update message 66 include a chronological interval (which may be extended until the next time the user initiates a call from or receives a call at the MS 20 or next time when the MS opens a channel for data connectivity); when the display counter or hit counter reaches a predetermined level; at a non-recurring predetermined time such as when an ad expires; and any time a new or replacement ad is downloaded to the MS 20. Responsive to an advertisement update message 66 sent in the uplink direction, the contents of the ad cache 50 may be updated with updated or replacement or additional advertisements by messages in the downlink direction. Alternatively, such downlink advertisement updates may occur at other times or increments not necessarily associated with an uplink advertisement update message 66.

One advantage gained by certain embodiments of the present invention is that ads need not be associated only with requested web pages, as is typical in the prior art. For example, a user of the MS 20 may access an application that does not entail Internet access, such as an application that operates the camera 53. When the user selects entries at the keypad 40 or other input device in preparation to taking a picture, an associated advertisement such as for a service that compiles electronic photos into a physical album may then be displayed. The display may be immediate, such as a banner or window on the graphical display interface 36 that is juxtaposed so that the user can still view the camera-related application graphics, or it may be delayed until after some action related to the selected application is completed, such as a digital photo captured by the camera 53. In another example, an advertisement that is displayed in response to the user opening an email program may be delayed until a received email is read (such as where the email application is opened by the user clicking an icon indicating the user has a new email message) or an outgoing email is sent (such as where the email application is opened directly to a screen whereby the user drafts an email for sending). Regardless, the display counter is incremented. Should the user then select the advertisement, a link 54 is established with a broader network on which a server associated with the advertisement is resident, and further communications as between the user and the web page associated with the advertisement then follow, generally as known in the art between a MS and a server on the Internet.

FIG. 3 illustrates in schematic form communications that go between different nodes in embodiments of the invention. The starting point for FIG. 3 is the user 68 of the MS 20 having initiated an application (102 by example) of the MS 20, and an advertisement associated with or generated by selection of that application 102 is displayed. Not shown is that the display counter of the MS 20 is updated for that particular instance of the locally stored ad being displayed. FIG. 3 begins with the user 68 clicking on or otherwise selecting 70 the displayed advertisement. This selection 70 causes the application 102, within the MS 20, to increment 72 the ad click cache 52 of the memory 46, which may be a direct communication between the application 102 or indirect through some software architecture such as an application interlocking framework AIW that interconnects the various applications, their advertising identifiers, the ad cache, and the display and hit counters. The ad click cache 52 is incremented and no further action takes place until the time arrives to upload an advertisement update message 66 to the associated server 64. As detailed above, that time may be predicated on a certain threshold number of ad clicks in the ad click cache 52, as indicated 74 in FIG. 3, or may be based on a recurring or non-recurring chronological time period (Tuesdays at 2 PM, whenever the next advertisement expires, etc.). Alternatively, rather than ‘pushing’ the advertisement update message 66 from the MS 20 to the server 64, it may instead be ‘pulled’ from the broader network 56 by a link initiated by the server 64 (via the cellular network) and an update request message form that server 64 (or an associated server) to which the advertisement update message 66 is a reply. FIG. 3 illustrates communications concerning the hit counter, but the same may be used for updates to the display counter. Preferably, the same advertisement update message 66 carries information concerning both the display and the hit counters. The claims are not avoided by failing to update the display counter for a displayed ad to which the hit counter is updated. In such a variation, the total number of displays may be obtained merely by adding the recorded hits and recorded displays, as the recorded displays would then be only those displays that did not result in a hit.

The embodiments of this invention may be implemented by computer software embodied on a tangible storage medium and executable by a data processor 22 of the MS 20, or by hardware circuitry, or by a combination of software and hardware circuitry. Further in this regard it should be noted that the various functional blocks of FIG. 1, and the logical flow blocks of FIG. 2 may represent program steps, or interconnected logic circuits, blocks and functions, or a combination of program steps and logic circuits, blocks and functions for performing the specified tasks.

The design of integrated circuits such as the processor 22 is by and large a highly automated process. Complex and powerful software tools are available for converting a logic level design into a semiconductor circuit design ready to be etched and formed on a semiconductor substrate. Such programs, such as those provided by Avant! Corporation of Fremont, Calif. and Cadence Design, of San Jose, Calif. automatically route conductors and locate components on a semiconductor chip using well established rules of design as well as huge libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication. Software and/or hardware implementations of embodiments of the invention use various portions of the integrated circuit in a specific manner to result in the actions described above.

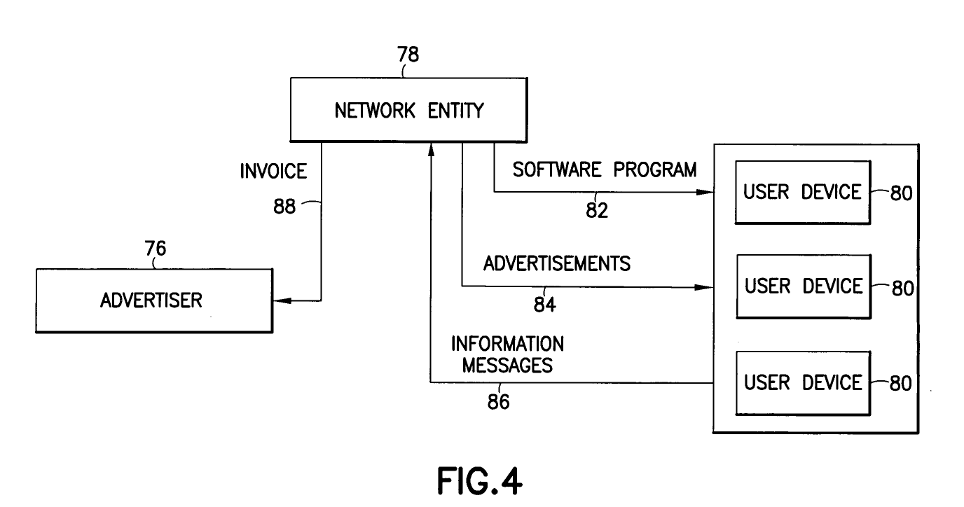

Additionally, the present invention may be used as a business tool to capture revenue from network advertising, as detailed with respect to FIG. 4. Assume for example that an advertiser 76 wishes to display advertisements to users of mobile stations 20, and that those advertisements link to a domain page on the Internet. Assume further that a network entity 78 operates a geographic cell-based wireless communication network over which certain mobile stations communicate, the mobile stations being user devices. Mobile stations represent one embodiment of user devices 80, and are particularly described above and with respect to FIGS. 1-3. A personal computer or any entity capable of communicating with the broader network may be a user device. Note at the outset that the advertiser 76 need not be the entity operating the domain and responsible for its content; an intermediary broker or advertising firm may act as agent for the domain operator, who is the true beneficiary of successful advertising. Note also that the network entity 78 need not be an operator of cellular telephony base stations and related radio nodes, but may be an owner of Internet servers or an entity that rents, leases, or otherwise commissions processing and/or storage capability from Internet Service Providers who may actually own the servers.

As shown in FIG. 4, the network entity 78 downloads to the user devices 80 a computer software program 82, which has instructions for displaying an advertisement, locally stored in the user device 80, on a local display interface of that device 80. The program further has instructions for keeping a count of instances in which the advertisement was displayed on at the user device, and instructions for sending the message that contains the information in response to a triggering condition. The information is detailed above, and may be the number of instances the advertisement was displayed, the number of times a user selected the advertisement, contextual statistical information, and the like that is locally stored on each user device 80. Of course, once this program is downloaded onto the user devices 80, any other party may use the program as downloaded to the user devices 80 to exploit the advantages of this invention, so the invention is not limited to downloading the program but to using it for the described purposes. The network entity 78 then downloads an advertisement 84 in electronic form to at least one user device 80 but preferably to all that are operable to receive such a download. Advertisements may take the form of a pop-up ad, a banner ad disposed alongside an open application, or any number of forms. Upon a triggering event that may be provided with the software program or that may be a separate request message from the network entity 78, most and preferably all of the user devices 80 send, and the network entity 78 receives from each user device 80 responding to the trigger condition, a message 86 that contains information concerning multiple instances of the advertisement being displayed on that particular user device. The network entity 78 then compiles the information, and invoices 88 the advertiser 76 in an amount that is based, at least in part, on the information received from the user device. This amount may depend on the context statistical information (e.g., some advertisers would pay a premium for their ads being associated with a particular application), and may derive from the total number of instances the ad was displayed, the number of times it was displayed on unique user devices, the number of times the ad vas selected by users of the user devices, and the like as detailed above.

From the above it is clear that the network entity 78 has a transmitter for downloading electronic advertisements to a plurality of user devices 80 (which store the advertisements locally), and a receiver for receiving from each of the user devices 80 a message that contains information concerning multiple instances of the advertisement being displayed on that user device. Where the network entity 78 is a plurality of base stations of a cellular telephony network, the transmitter and receiver are traditional wireless transceivers. Where the network entity 78 is one or more Internet, intranet, or other electronic network servers, the transmitter and receiver are broadly construed to be electronic means for sending and receiving the messages over the Internet, intranet, or other broader communications network. The network entity also has some means for generating an invoice to the advertiser 76, where the invoice amount is based at least in part on a consolidation of the information in the messages received from the user devices 80. The means for generating an invoice may be electronic, as where a processor compiles relevant fields of the messages and electronically sends the invoice to the advertiser 76, or it may be a traditional accounting department the prepares, reviews, and mails a hard copy of the invoice to the advertiser 76.

While the present invention is operable and useful in any network environment, it is perceived that the most advantageous use may be had in cellular-based networks where network operators seek additional revenues as their revenues from wireless voice services become increasingly commoditized over time. As such, the network entity in that embodiment meshes two networks, the cellular telephony network and the Internet. Alternatively, where the network operator is on the Internet directly and the user devices are not limited to mobile stations, the contextual statistical information is seen as more valuable so that revenues may be tied more directly to placement of advertising where a user is most likely to consciously see and absorb it, rather than a generic, non-directed pop-up ad associated with calling up a requested web page as in the prior art.

Although described in the context of particular embodiments, it will be apparent to those skilled in the art that a number of modifications and various changes to these teachings may occur. Thus, while the invention has been particularly shown and described with respect to one or more preferred embodiments thereof, it will be understood by those skilled in the art that certain modifications or changes may be made therein without departing from the scope and spirit of the invention as set forth above, or from the scope of the ensuing claims.

What is claimed is:

1. A method for tracking electronic activity on a device comprising:
locally storing an advertisement on a memory of a device;
using the device to display the advertisement on at least two distinct occasions;
for each individual occasion, locally storing information concerning display of the advertisement by the device; and
responsive to a triggering condition, sending the information of the at least two occasions in a single message to a network entity.

2. The method of claim 1, wherein the device displays the advertisement responsive to initiating an application that is stored in a memory of the device.

3. The method of claim 1, wherein the information concerning display comprises a number of times over a finite time period that the advertisement was displayed.

4. The method of claim 1, wherein the information concerning display comprises a number of times over a finite time period that the advertisement was selected by a user of the device.

5. The method of claim 1, wherein sending the information comprises wirelessly sending the information.

6. The method of claim 1, wherein the triggering condition comprises at least one of: a number of times the advertisement was displayed and a number of times the advertisement was selected by a user of the device.

7. The method of claim 1, wherein the triggering condition comprises at least one of a recurring and a non-recurring chronologically based event.

8. The method of claim 1, wherein the triggering condition comprises an update request message received at the device.

9. The method of claim 8, wherein the update request message is received over a wireless link.

10. The method of claim 1, wherein the device comprises a mobile station.

11. An electronic device for presenting advertisements to a user, comprising:
a graphical display interface;
a memory comprising an ad cache for storing an advertisement and applications;
a user input mechanism;
means for linking to a broader communications network; and
a digital processor coupled to each of the display interface, the memory, the user input mechanism, and the means for linking, wherein for each distinct instance at which the advertisement is displayed at the graphical user interface, the processor operates to store information in the memory concerning display of that advertisement, and to send an indication of said information to the broader communication network via the means for linking in response to a triggering condition.

12. The electronic device of claim 1 1, wherein the memory further comprises a display counter for storing an accumulated number of times the advertisement was displayed.

13. The electronic device of claim 1 1, wherein the memory further comprises a hit counter for storing an accumulated number of times the advertisement was selected at the user input mechanism by a user of the device.

14. The electronic device of claim 1 1, wherein the processor operates to display the advertisement responsive to initiating at least one of the applications.

15. The electronic device of claim 11, wherein the means for linking comprises an antenna, transmitting circuitry, and receiving circuitry.

16. The electronic device of claim 10, wherein the triggering condition comprises at least one of: a number of times the advertisement was displayed and a number of times the advertisement was selected by a user of the device.

17. The electronic device of claim 10, wherein the triggering condition comprises at least one of a recurring and a non-recurring chronologically based event.

18. The electronic device of claim 10, wherein the triggering condition comprises an update request message received at the device.

19. The electronic device of claim 18, wherein the update request message is received over a wireless link.

20. An apparatus comprising:
means for graphically displaying data to a user;
local means for electronically storing data, computer application instructions, and graphical advertisements;
means for linking to a broader communications network; and
processing means for updating information in the local means for storing, the information concerning display of the graphical advertisement at the means for graphically displaying, said processor means further responsive to a triggering condition for sending an indication of said information via the means for linking.

21. The apparatus of claim 20 comprising a portable wireless handheld device, wherein:
said means for graphically displaying data comprises a graphical display interface;
said local means comprises a computer readable storage medium; said means for linking comprises an antenna and transceiver circuitry; and
said processing means comprises a digital processor.

22. A program of machine-readable instructions, tangibly embodied on an information bearing medium and executable by a digital data processor, to perform actions directed toward recording advertising activity, the actions comprising:
displaying an advertisement from a local memory on at least two distinct occasions;
for each individual occasion, storing information concerning display of the advertisement by the device; and
responsive to a triggering condition, sending the information of the at least two occasions in a single message to a network entity.

23. A program of claim 22, wherein displaying an advertisement from a local memory comprises displaying the advertisement responsive to an application stored in a memory of the device being initiated.

24. The program of claim 22, wherein the information concerning display comprises a number of times over a finite time period that the advertisement was displayed.

25. The program of claim 22, wherein the information concerning display comprises a number of times over a finite time period that the advertisement was selected by a user of the device.

26. A method of doing business over a network, comprising:
downloading to at least one user device an advertisement in electronic form;
receiving from the user device a message that contains information concerning multiple instances of the advertisement being displayed on the user device; and
invoicing an advertiser in an amount based on the information received from the user device.

27. The method of claim 26, further comprising, prior to downloading the advertisement, downloading to the at least one user device a computer software program, the computer software program comprising instructions for displaying the advertisement on a local display interface, instructions for keeping a count of instances in which the advertisement was displayed at the user device, and instructions for sending the message that contains the information in response to a triggering condition.

28. The method of claim 27, wherein the computer software program further comprises the triggering condition.

29. The method of claim 26, further including, prior to receiving the message, sending a request message for the information to the user device.

30. The method of claim 26, wherein the network is a wireless cellular telephony network and the user device comprises a mobile station.

31. The method of claim 26, wherein the amount based on the information comprises an amount based at least in part on a number of instances that the advertisement was displayed on a user device.

32. The method of claim 26, wherein the amount based on information comprises an amount based at least in part on a number of instances that a user of the device selected the displayed advertisement to visit a domain linked by the displayed advertisement.

33. The method of claim 26, wherein
downloading to at least one user device comprises downloading to a plurality of user devices;
receiving from the user device comprises receiving from each of at least some of the plurality of user devices a message that contains information concerning multiple instances of the advertisement being displayed on that user device; and
invoicing an advertiser comprising invoicing in an amount based on a consolidation of each of the received messages.

34. A network entity comprising:
a transmitter for downloading electronic advertisements to a plurality of user devices for local storage thereon;
a receiver for receiving from each of at least some of the plurality of user devices a message that contains information concerning multiple instances of the advertisement being displayed on that user device; and
means for generating an invoice to an advertiser, an amount of the invoice based at least in part on a consolidation of the information in the received messages.

35. The network entity of claim 34 comprising an operator of cell-based mobile telephony base stations.

36. The network entity of claim 34 comprising an operator of Internet servers.

37. The network entity of claim 34, wherein the means for generating comprises a transmitter that electronically sends an invoice to the advertiser.

38. The network entity of claim 34, wherein the means for generating comprises an accounting department that mails a hard copy of the invoice.

39. A program of machine-readable instructions, tangibly embodied on an information bearing medium and executable by a digital data processor, to perform actions directed toward displaying an advertisement on user equipment, the actions comprising:
responsive to an active application on the user equipment, displaying on a graphical interface of the user equipment an advertisement that is stored on a local memory of the user equipment, where the application does not require communications with a network.

40. The program of claim 39, wherein the advertisement includes a hyperlink that when selected by a user of the user equipment, initiates a second application that requires communication with a network.

41. -The program of claim 40, wherein the second application comprises an Internet browser program.

42. The program of claim 40, wherein the actions further comprise:
for each individual occasion of the hyperlink being selected, storing information concerning said selection.

43. The program of claim 42, wherein the actions further comprise:
sending a message with the information concerning said selection over a communication network in response to a triggering condition.

44. The program of claim 39, wherein the actions further comprise:
for each individual occasion of the advertisement being displayed, storing information concerning said display.

45. The program of claim 44, wherein the actions further comprise:
sending a message with the information concerning said display over a communication network in response to a triggering condition.
